(19) United States
(12) Patent Application Publication
(10) Pub. No.: US 2018/0137679 A1
(43) Pub. Date: May 17, 2018

(54) STL FILE COUPLING METHOD

(71) Applicant: DAEGUNTECH CO., LTD., Changwon-si (KR)

(72) Inventors: Ki Soo SHIN, Changwon-si (KR); Song Hwa PARK, Gimhae-si (KR)

(21) Appl. No.: 15/714,183

(22) Filed: Sep. 25, 2017

(30) Foreign Application Priority Data
Nov. 15, 2016 (KR) 10-2016-0151738

(51) Int. Cl. G06T 17/30; G06T 17/05; G06T 19/20; G06F 17/16

(52) U.S. Cl. CPC G06T 17/30; G06T 17/05; B33Y 10/00; G06F 17/16; G06T 19/20

(57) ABSTRACT

Provided is an STL file coupling method including: analyzing models of STL files to define surfaces of the models as to triangular pixels, and selecting triangles to be coupled among the triangular pixels; determining directionality of a first triangle of a first file and a second triangle of a second file in terms of a clockwise direction or a counterclockwise direction; calculating first and second normal vectors from the first and second triangles, respectively; calculating a cross angle between the first and second normal vectors; arranging the first and second triangles to face each other in parallel; calculating a first central point of the first triangle and a second central point of the second triangle to calculate a distance between the first and second central points; and moving the second triangle with respect to the first triangle by the calculated distance to couple the first triangle to the second triangle.

### BACKGROUND OF THE INVENTION

### 1. Field of the Invention

The present invention relates to an STL file, and more particularly, to an STL file coupling method for simply coupling at least two STL files which are different from each other.

### 2. Description of the Related Art

A three-dimensional printer (3D printer) is a machine that prints out a stereoscopic shape of a real object based on 3D drawings created by a computer design program. The 3D printer is ranked in the second place of a list of top 10 emerging technologies published by the World Economic Forum in 2012.

Production using 3D printers includes modeling, printing, and finishing. The modeling is a step of creating a 3D drawing by using a computer aided design (3D CAD), a 3D modeling program, or a 3D scanner.

The printing is a step of creating an object by using the 3D drawing produced in the modeling process, through stacking, cutting and the like. The time required for the printing depends on the size and complexity of the workpiece. In addition, the finishing is a step in which the produced workpiece is complemented.

However, there is no program to couple mutually different CAD data, which are created as the STL file.

### DOCUMENT OF RELATED ART

### Patent Document

(Patent document 1) Korean Patent Registration No. 10-1635431

### SUMMARY OF THE INVENTION

To solve the problems described above, an object of the present invention is to provide an STL file coupling method capable of simply analyzing objects on CAD data to couple files to each other in a three-dimensional space of a program for analysis.

To achieve the objects described above, according to the present invention, there is provided an STL file coupling method including: a first step of analyzing models of STL files which are different from each other to define surfaces of the models as to triangular pixels in a three-dimensional space, and selecting triangles to be coupled among the triangular pixels; a second step of determining directionality of a first triangle of a first file and a second triangle of a second file by defining the first and second triangles in terms of a clockwise direction or a counterclockwise direction based on a left-handed coordinate system; a third step of calculating a first normal vector and a second normal vector from the first triangle and the second triangle, respectively; a fourth step of calculating a magnitude of a cross angle between the first normal vector and the second normal vector; a fifth step of arranging the first triangle and the second triangle to face each other in parallel based on the directionality determined in the second step and the cross angle calculated in the fourth step; a sixth step of calculating a first central point and a second central point, which are central points of the first triangle and the second triangle, respectively, to calculate a distance between the first central point and the second central point; and a seventh step of moving the second triangle with respect to the first triangle by the distance calculated in the sixth step to couple the first triangle to the second triangle.

In addition, vertexes of the first triangle may include a first-first vertex having a coordinate P0 (X11, Y11, Z11), a first-second vertex having a coordinate P1 (X12, Y12, Z12), and a first-third vertex having a coordinate P2 (X13, Y13, Z13), and vertexes of the second triangle may include a second-first vertex having a coordinate P3 (X21, Y21, Z21), a second-second vertex having a coordinate P4 (X22, Y22, Z22), and a second-third vertex having a coordinate P5 (X23, Y23, Z23). Further, in the third step, a first vector (V0) of the first triangle may be Vector (X12-X11, Y12-Y11, Z12-Z11), a second vector (V1) of the first triangle may be Vector (X13-X12, Y13-Y12, Z13-Z12), a third vector (V2) of the second triangle may be Vector (X22-X21, Y22-Y21, Z22-Z21), a fourth vector (V3) of the second triangle may be Vector (X23-X22, Y23-Y22, Z23-Z22), a normal vector (M0) of the first triangle may be calculated by V0×V1, and a normal vector (M1) of the second triangle may be calculated by V2×V3.

In addition, an angle between the normal vector (M0) of the first triangle and the normal vector (M1) of the second triangle may be calculated by a following equation:

$$cos θ = \frac{\vert {{M}_{0}}^{} \cdot {{M}_{1}}^{} \vert}{\vert {{M}_{0}}^{} \vert \vert {{M}_{1}}^{} \vert} = \frac{\vert {A}_{0} {A}_{1} + {B}_{0} {B}_{1} + {C}_{0} {C}_{1} \vert}{\sqrt{{A}_{0}^{2} + {B}_{0}^{2} + {C}_{0}^{2}} \sqrt{{A}_{1}^{2} + {B}_{1}^{2} + {C}_{1}^{2}}}$$

In addition, in the sixth step, when a center of gravity (S0) of the first triangle has a coordinate (A3, B3, C3), and a center of gravity (S1) of the second triangle has a coordinate (A4, B4, C4), following equations may be calculated:

$$[ \begin{matrix}A 3 \\ B 3 \\ C 3 \\ 1\end{matrix} ] = [ \begin{matrix}1 & 0 & 0 & A 4 \\ 0 & 1 & 0 & B 4 \\ 0 & 0 & 1 & C 4 \\ 0 & 0 & 0 & 1\end{matrix} ] [ \begin{matrix}X \\ Y \\ Z \\ 1\end{matrix} ] , [ \begin{matrix}A 3 \\ B 3 \\ C 3 \\ 1\end{matrix} ] = [ \begin{matrix}X + A 4 \\ Y + B 4 \\ Z + C 4 \\ 1\end{matrix} ] , \\ X = A 4 - A 3 , Y = B 4 - B 3 , Z = C 4 - C 3.$$

In addition, the second triangle may be moved with respect to the first triangle by the distance calculated in the sixth step, which corresponds to (A4-A3) on an X axis, (B4-B3) on a Y axis, and (C4-C3) on a Z axis, so as to couple the first triangle to the second triangle.

According to the present invention, the STL file coupling method has the following effects.

The STL files that are different from each other can be coupled by a simple operation of a program, and the coupling result can be outputted by the 3D printer after confirming the coupling result, so that the 3D printer can be widely used.

### BRIEF DESCRIPTION OF THE DRAWINGS

FIG. 1 is a flowchart showing coupling steps of an STL file coupling method according to the present invention.

FIG. 2 is a view showing a configuration of an STL file according to the present invention.

FIG. 3 is a view showing a surface to be coupled during a coupling process in the STL file coupling method according to an example of the present invention.

### DETAILED DESCRIPTION OF THE INVENTION

Hereinafter, an STL file coupling method according to preferred embodiments of the present invention will be described with reference to the accompanying drawings.

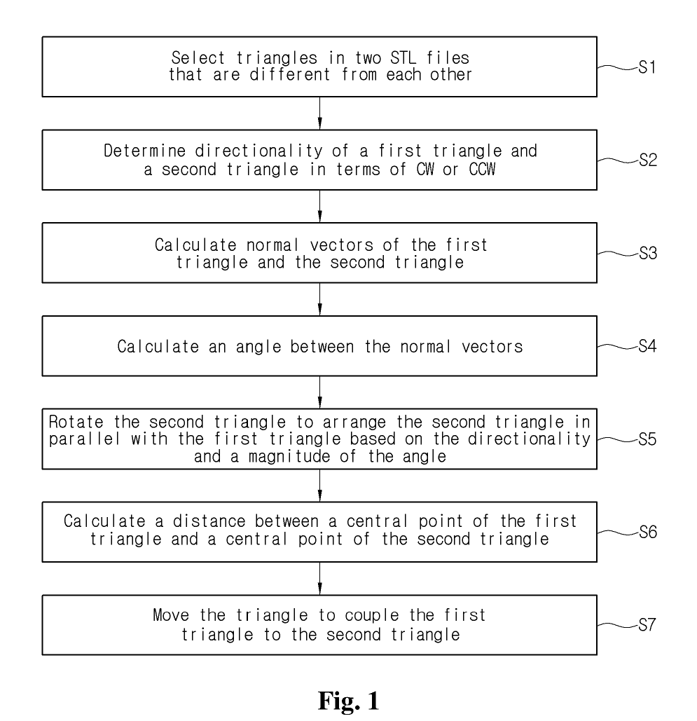

According to the present invention, as shown in FIG. 1, an STL file coupling method may include: a first step S1 of analyzing models of STL files which are different from each other to define surfaces of the models as to triangular pixels in a three-dimensional space, and selecting triangles to be coupled among the triangular pixels; a second step S2 of determining directionality of a first triangle of a first file and a second triangle of a second file by defining the first and second triangles in terms of a clockwise direction or a counterclockwise direction based on a left-handed coordinate system; a third step S3 of calculating a first normal vector and a second normal vector from the first triangle and the second triangle, respectively; a fourth step S4 of calculating a magnitude of a cross angle between the first normal vector and the second normal vector; a fifth step S5 of arranging the first triangle and the second triangle to face each other in parallel based on the directionality determined in the second step and the cross angle calculated in the fourth step; a sixth step S6 of calculating a first central point and a second central point, which are central points of the first triangle and the second triangle, respectively, to calculate a distance between the first central point and the second central point; and a seventh step S7 of moving the second triangle with respect to the first triangle by the distance calculated in the sixth step to couple the first triangle to the second triangle.

1. First Step S1

First, an STL file includes one Model3DGroup, and Model3DGroup includes a plurality of GeometryModel3D. In addition, the STL file stores information on a triangle, which serves as a basic unit, in the MeshGeometry3D, and GeometryModel3D includes MeshGeometry3D and material information. When selecting a triangle in the STL file, one triangle in one MeshGeometry3D is selected from one Model3DGroup.

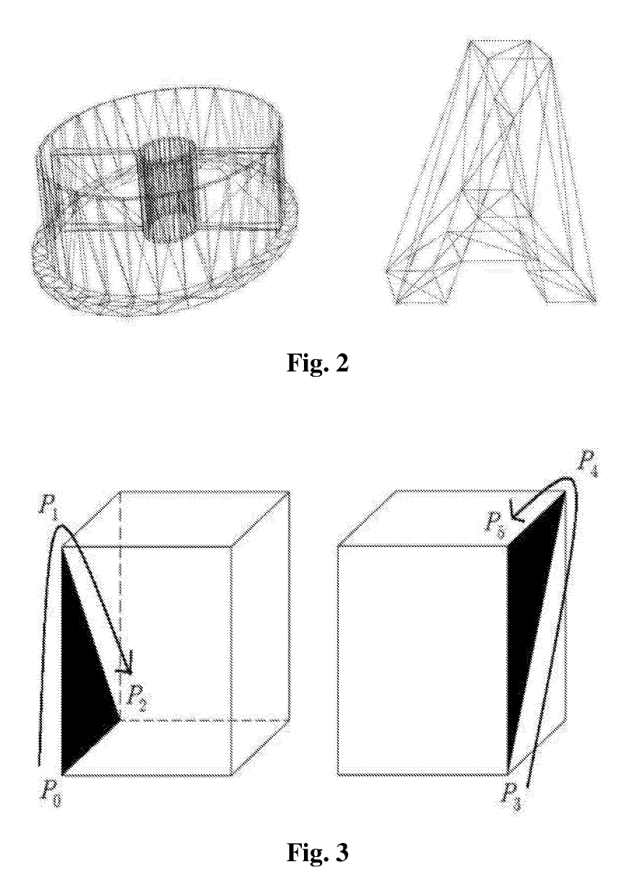

As shown in FIG. 2, in the coupling method according to the present invention, the surfaces of models in STL files which are different from each other are defined as to a plurality of triangular pixels. A triangle to be coupled is selected among the triangular pixels. Among the two selected triangles, a triangle of a first file is referred to as a first triangle, and a triangle of a second file is referred to as a second triangle.

2. Second Step S2

In the first file and the second file, the directionality of the first triangle of the first file and the second triangle of the second file is determined by defining the first and second triangles in terms of a clockwise direction or a counterclockwise direction based on a left-handed coordinate system.

For example, as shown in FIG. 3, it is confirmed that the first triangle of the first file on the left side has clockwise directionality, and the second triangle of the second file on the right side has counterclockwise directionality, thereby identifying what is served as the surface.

In this case, vertexes of the first triangle include a first-first vertex having a coordinate P0 (X11, Y11, Z11), a first-second vertex having a coordinate P1 (X12, Y12, Z12), and a first-third vertex having a coordinate P2 (X13, Y13, Z13).

In addition, vertexes of the second triangle include a second-first vertex having a coordinate P3 (X21, Y21, Z21), a second-second vertex having a coordinate P4 (X22, Y22, Z22), and a second-third vertex having a coordinate P5 (X23, Y23, Z23).

3. Third Step S3

A normal vector of the first triangle in the first file and a normal vector of the second triangle in the second file are obtained. The normal vectors are obtained to calculate a relative angle between the first triangle and the second triangle.

A first vector V0 of the first triangle is Vector (X12-X11, Y12-Y11, Z12-Z11), a second vector V1 of the first triangle is Vector (X13-X12, Y13-Y12, Z13-Z12), a third vector V2 of the second triangle is Vector (X22-X21, Y22-Y21, Z22-Z21), and a fourth vector V3 of the second triangle is Vector (X23-X22, Y23-Y22, Z23-Z22).

In the calculation, a normal vector M0 of the first triangle is obtained by V0×V1, and a normal vector M1 of the second triangle is obtained by V2×V3.

When a=(a1,a2,a3), and

b=(B1,B2,B3),

a×b=(a2*b3−a3*b2,a3*b1−a1*b3,a1*b2−a2*b1) [Equation 1]

According to Equation 1, the normal vector M0 of the first triangle has a value of (A0, B0, C0), and the normal vector M1 of the second triangle has a value of (A1, B1, C1).

4. Fourth Step S4

An angle θ between the normal vectors of the first triangle and the second triangle, which are obtained in the above process, is calculated.

In more detail, the angle θ between the normal vector M0 of the first triangle and the normal vector M1 of the second triangle is calculated by the following equation.

$$cos θ = \frac{\vert {{M}_{0}}^{} \cdot {{M}_{1}}^{} \vert}{\vert {{M}_{0}}^{} \vert \vert {{M}_{1}}^{} \vert} = \frac{\vert {A}_{0} {A}_{1} + {B}_{0} {B}_{1} + {C}_{0} {C}_{1} \vert}{\sqrt{{A}_{0}^{2} + {B}_{0}^{2} + {C}_{0}^{2}} \sqrt{{A}_{1}^{2} + {B}_{1}^{2} + {C}_{1}^{2}}} \qquad [ Equation 2 ]$$

5. Fifth Step S5

The second file is rotated with respect to the first file to arrange the first triangle and the second triangle to face each other in parallel based on the directionality determined in the second step and the angle calculated in the fourth step.

6. Sixth Step S6

A first central point and a second central point, which are central points of the first triangle and the second triangle, respectively, are obtained to calculate a distance between the first central point and the second central point.

In more detail, vertexes of the first triangle include a first-first vertex having a coordinate P0 (X11, Y11, Z11), a first-second vertex having a coordinate P1 (X12, Y12, Z12), and a first-third vertex having a coordinate P2 (X13, Y13, Z13), and vertexes of the second triangle include a second-first vertex having a coordinate P3 (X21, Y21, Z21), a second-second vertex having a coordinate P4 (X22, Y22, Z22), and a second-third vertex having a coordinate P5 (X23, Y23, Z23).

A center of gravity S0 of the first triangle has a coordinate ((X11+X12+X13)/3, (Y11+Y12+Y13)/3, (Z11+Z12+Z13)/3), and a center of gravity S1 of the second triangle has a coordinate ((X21+X22+X23)/3, (Y21+Y22+Y23)/3, (Z21+Z22+Z23)/3).

In this case, the center of gravity S0 of the first triangle will be set as to have a coordinate (A3, B3, C3), and the center of gravity S1 of the second triangle will be set as to have a coordinate (A4, B4, C4).

By using the two centers of gravity, the movement distance is calculated by the following equation.

$$[ \begin{matrix}A 3 \\ B 3 \\ C 3 \\ 1\end{matrix} ] = [ \begin{matrix}1 & 0 & 0 & A 4 \\ 0 & 1 & 0 & B 4 \\ 0 & 0 & 1 & C 4 \\ 0 & 0 & 0 & 1\end{matrix} ] [ \begin{matrix}X \\ Y \\ Z \\ 1\end{matrix} ] , [ \begin{matrix}A 3 \\ B 3 \\ C 3 \\ 1\end{matrix} ] = [ \begin{matrix}X + A 4 \\ Y + B 4 \\ Z + C 4 \\ 1\end{matrix} ] , \\ X = A 4 - A 3 , Y = B 4 - B 3 , Z = C 4 - C 3. \qquad [ Equation 3 ]$$

7. Seventh Step S7

The second triangle is moved with respect to the first triangle by the distance calculated in the sixth step to couple the first triangle to the second triangle, so that the first file may be coupled to the second file.

In other words, the movement is performed by (A4-A3) on an X axis, (B4-B3) on a Y axis, and (C4-C3) on a Z axis. Accordingly, the first file may be coupled to the second file.

Hereinafter, a process of coupling STL files according to the present invention will be described in detail with reference to specific embodiments.

It is assumed that the vertexes of the first triangle in the first file are P0 (1, 0, 0), P1 (1, 0, 1), and P2 (0, 0, 0), and the vertexes of the second triangle in the second file are P3 (1, 4, 0), P4 (0, 4, 1), and P5 (1, 4, 1), so that the first triangle is separated from the second triangle by 4 on the Y axis.

In this case, as shown in FIG. 3, the first triangle has clockwise directionality, and the second triangle has counterclockwise directionality.

V0=(0, 0, 1) and V1=(−1, 0, −1) are calculated by the calculation formula to obtain the normal vector of the first triangle, and V2=(−1, 0, 1) and V3=(1, 0, 0) are calculated to obtain the normal vector of the second triangle.

The normal vector M0 of the first triangle is obtained to be (0, −1, 0), the normal vector M1 of the second triangle is obtained to be (0, 2, 0), and the angle between two planes defined by the vectors results in θ=180°.

Thereafter, the second file is rotated with respect to the first file, so that the first triangle and the second triangle are rotated to be arranged in parallel. Then, the position of the first triangle can be defined by the vertexes P3′ (1, 4, 0), P4′ (0, 4, 0), and P5′ (1, 4, 1).

Next, the central points of triangular objects are obtained. In the case of the first triangle, the center of gravity S0 is (2/3, 0, 1/3), and in the case of the second triangle, the center of gravity S1 is (2/3, 4, 1/3).

According to the above calculation formula, values of X=0, Y=4, and Z=0 are obtained. When the second triangle is moved by 4 toward the first triangle, the first triangle and the second triangle are coupled to each other, so that the first file is entirely coupled to the second file.

As described above, in the technical configuration of the present invention, those skilled in the art will appreciate that various changes and modifications can be made without departing from the spirit and essential characteristics of the present invention.

Therefore, it is understood that although the above embodiments have been disclosed for illustrative purposes, the present invention is not limited thereto. In addition, the scope of the present invention is defined by the accompanying claims, and shall be construed as including all changes and modifications derived from inventions covered by the claims of the present invention and their equivalents.

What is claimed is:

1. An STL file coupling method comprising:
a first step of analyzing models of STL files which are different from each other to define surfaces of the models as to triangular pixels in a three-dimensional space, and selecting triangles to be coupled among the triangular pixels;
a second step of determining directionality of a first triangle of a first file and a second triangle of a second file by defining the first and second triangles in terms of a clockwise direction or a counterclockwise direction based on a left-handed coordinate system;
a third step of calculating a first normal vector and a second normal vector from the first triangle and the second triangle, respectively;
a fourth step of calculating a magnitude of a cross angle between the first normal vector and the second normal vector;
a fifth step of arranging the first triangle and the second triangle to face each other in parallel based on the directionality determined in the second step and the cross angle calculated in the fourth step;
a sixth step of calculating a first central point and a second central point, which are central points of the first triangle and the second triangle, respectively, to calculate a distance between the first central point and the second central point; and
a seventh step of moving the second triangle with respect to the first triangle by the distance calculated in the sixth step to couple the first triangle to the second triangle.

2. The STL file coupling method of claim 1, wherein
vertexes of the first triangle include a first-first vertex having a coordinate P0 (X11, Y11, Z11), a first-second vertex having a coordinate P1 (X12, Y12, Z12), and a first-third vertex having a coordinate P2 (X13, Y13, Z13), and
vertexes of the second triangle include a second-first vertex having a coordinate P3 (X21, Y21, Z21), a second-second vertex having a coordinate P4 (X22, Y22, Z22), and a second-third vertex having a coordinate P5 (X23, Y23, Z23), and
wherein, in the third step, a first vector (V0) of the first triangle is Vector (X12-X11, Y12-Y11, Z12-Z11), a second vector (V1) of the first triangle is Vector (X13-X12, Y13-Y12, Z13-Z12), a third vector (V2) of the second triangle is Vector (X22-X21, Y22-Y21, Z22-Z21), a fourth vector (V3) of the second triangle is Vector (X23-X22, Y23-Y22, Z23-Z22),
a normal vector (M0) of the first triangle is calculated by V0×V1, and a normal vector (M1) of the second triangle is calculated by V2×V3.

3. The STL file coupling method of claim 2, wherein an angle between the normal vector (M0) of the first triangle and the normal vector (M1) of the second triangle is calculated by a following equation:
$$cos θ = \frac{\vert {{M}_{0}}^{} \cdot {{M}_{1}}^{} \vert}{\vert {{M}_{0}}^{} \vert \vert {{M}_{1}}^{} \vert} = \frac{\vert {A}_{0} {A}_{1} + {B}_{0} {B}_{1} + {C}_{0} {C}_{1} \vert}{\sqrt{{A}_{0}^{2} + {B}_{0}^{2} + {C}_{0}^{2}} \sqrt{{A}_{1}^{2} + {B}_{1}^{2} + {C}_{1}^{2}}}$$

4. The STL file coupling method of claim 1, wherein, in the sixth step, when a center of gravity (S0) of the first triangle has a coordinate (A3, B3, C3), and a center of gravity (S1) of the second triangle has a coordinate (A4, B4, C4), following equations are calculated:
$$[ \begin{matrix}A 3 \\ B 3 \\ C 3 \\ 1\end{matrix} ] = [ \begin{matrix}1 & 0 & 0 & A 4 \\ 0 & 1 & 0 & B 4 \\ 0 & 0 & 1 & C 4 \\ 0 & 0 & 0 & 1\end{matrix} ] [ \begin{matrix}X \\ Y \\ Z \\ 1\end{matrix} ] , [ \begin{matrix}A 3 \\ B 3 \\ C 3 \\ 1\end{matrix} ] = [ \begin{matrix}X + A 4 \\ Y + B 4 \\ Z + C 4 \\ 1\end{matrix} ] , \\ X = A 4 - A 3 , Y = B 4 - B 3 , Z = C 4 - C 3.$$

5. The STL file coupling method of claim 4, wherein the second triangle is moved with respect to the first triangle by the distance calculated in the sixth step, which corresponds to (A4-A3) on an X axis, (B4-B3) on a Y axis, and (C4-C3) on a Z axis, so as to couple the first triangle to the second triangle.
